(19) United States
(12) Patent Application Publication
(10) Pub. No.: US 2026/0143306 A1
(43) Pub. Date: May 21, 2026

(54) COMMUNICATION DEVICE ACTIVATIONS

(71) Applicant: Hewlett-Packard Development Company, L.P., Spring, TX (US)

(72) Inventors: Andre da Fonte Lopes da Silva, Palo Alto, CA (US); Carol Ozaki, Palo Alto, CA (US); Isaac Lagnado, Spring, TX (US)

(73) Assignee: Hewlett-Packard Development Company, L.P., Spring, TX (US)

(21) Appl. No.: 19/123,170

(22) PCT Filed: Oct. 27, 2022
(86) PCT No.: PCT/US2022/047991

§ 371 Date: Apr. 22, 2025

(51) Int. Cl. H04W 4/029; H04L 65/1069; H04L 67/52; H04W 4/80

(52) U.S. Cl. CPC H04W 4/029; H04L 65/1069; H04L 67/52; H04W 4/80

(57) ABSTRACT

In some examples, the disclosure describes a device that includes a device that includes a processor to: determine when the device has moved from a first location to a second location based on data received from the motion sensor device, activate the receiver device to identify a first signal type in response to the device moving from the first location to the second location, receive a beacon of the first signal type at the receiver device, activate the communication device to identify a second signal type in response to receiving the beacon at the receiver device, receive a signal of the second signal type, and establish a communication session with a transmitting device of the signal based on information from the signal.

### BACKGROUND

Computing devices are utilized to perform particular functions. In some examples, computing devices utilize battery power that is limited when the computing device is not connected to an electrical power source. In some examples, computing devices are mobile computing devices that are carriable or moveable from a first location to a second location.

### BRIEF DESCRIPTION OF THE DRAWINGS

FIG. 1 illustrates an example of a system for communication device activations.

FIG. 2 illustrates an example of a system for communication device activations.

FIG. 3 illustrates an example of a device for communication device activations.

FIG. 4 illustrates an example of a memory resource for communication device activations.

FIG. 5 illustrates an example of a system for communication device activations.

### DETAILED DESCRIPTION

A user may utilize a computing device for various purposes, such as for business and/or recreational use. As used herein, the term computing device refers to an electronic device having a processor and a memory resource. Examples of computing devices include, for instance, a laptop computer, a notebook computer, a desktop computer, an all-in-one (AIO) computing device, and/or a mobile device (e.g., a smart phone, tablet, personal digital assistant, smart glasses, a wrist-worn device, etc.), among other types of computing devices.

In some examples, the computing device is a mobile computing device that is portable to a plurality of different locations. For example, a user may bring the computing device into a plurality of different workspaces, conference rooms, and/or offices within a building. In some examples, the portable computing devices include hardware that can collect audio, video, and/or other data. For example, the computing devices can include still image cameras, video cameras, microphones, infrared cameras, biometric sensors, and/or other hardware that can be coupled to the computing devices.

In some examples, the computing devices are used with applications to communicate with remote devices. For example, computing devices are utilized with conferencing applications to share audio data, visual data, and/or other data with remote computing devices. In some examples, a plurality of users may utilize a corresponding plurality of computing devices within a similar area. In these examples, the plurality of users may form a group within the similar area to communicate as a group with a plurality of remote devices utilizing an area profile. The area profiles can be utilized for conferencing sessions with remote devices. In this way, a plurality of users that utilize separate computing devices are able to communicate with an area computing device through an ultrasonic wireless communication device. In this example, an area profile can be generated by the area computing device utilizing the audio data and video data collected from the plurality of computing devices within the area.

In some examples, a computing device may pair with the area computing device to establish a communication session with the area computing device. In these examples, the area computing device can utilize a communication session that utilizes a relatively high quantity of electrical energy. As described herein, the computing device can be a mobile computing device with a limited quantity of electrical power provided by a battery or other type of power source. In some examples, the computing device may utilize a relatively large quantity of electrical resources when searching for the area computing device when utilizing a high power communication device such as the ultrasonic wireless communication device.

The present disclosure relates to communication device activations that allow the computing device to conserve electrical resources and ensure privacy protection while still allowing the computing device to pair with or establish a communication session with the area computing device when the computing device is within communication range of the area computing device. For example, the present disclosure utilizes a motion sensor to determine when the computing device has moved locations. In this example, a low power receiver device or transceiver device (e.g., Bluetooth Low Energy (BLE), etc.) can be activated in response to a determination that the computing device has moved location. The lower power receiver device can receive a beacon or signal from a remote computing device such as the area computing device to indicate that the computing device is within communication range of the remote computing device. In this example, the high power transmitter device or high power transceiver device (e.g., ultrasonic communication device, etc.) can be activated in response to the determination that the computing device is within communication range of the remote computing device.

In this way, the computing device can establish a communication session utilizing the high power transceiver device without having to use the high power transceiver device to search for the remote computing device. Thus, the computing device can utilize relatively less electrical resources while still searching for the remote computing device. In addition, the computing device can establish a communication session with the remote computing device when the computing device is within communication range without having the ultrasonic transmitter device activated, which can result in potential pairing with unauthorized remote computing devices.

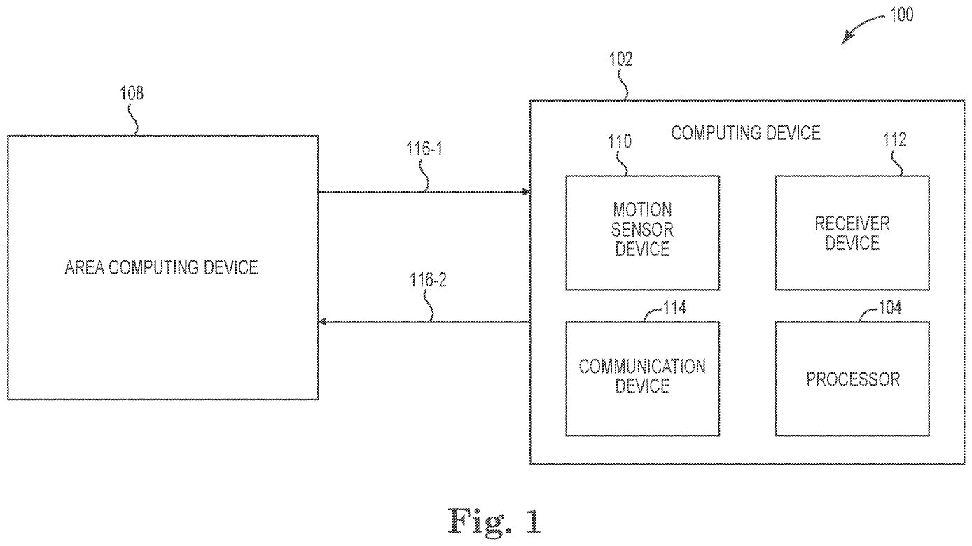

FIG. 1 illustrates an example of a system 100 for communication device activations. As described herein, the system 100 can include a computing device 102. The computing device 102 can include a processor 104 to instruct the other components of the computing device 102 to perform particular functions. For example, the processor 104 can be utilized to activate and/or deactivate the receiver device 112 and communication device 114 based on a status of the computing device 102.

The computing device 102 can be a mobile computing device that can be transported from a first location to a second location. For example, the computing device 102 can be a laptop, tablet, smartphone, smartwatch, among other computing devices that are relatively easy to transport from a first location to a second location.

In some examples, the system 100 includes an area computing device 108. The area computing device 108 can be a computing device that is positioned within a particular area. The area computing device 108 can be a remote computing device from the computing device 102. That is, the area computing device 108 may not be physically connected to the computing device 102. In some examples, the area computing device 108 is stationary within a particular designated area. For example, the area computing device 108 can be a conferencing computing device that is stationary within a particular conference room. In this example, the area computing device 108 can be utilized by computing devices within the particular conference room but may not be utilized by computing devices outside the particular conference room.

In this way, the computing device 102 may establish a communication session with the area computing device 108 when the computing device 102 is moved within the particular area of the area computing device 108. In addition, the computing device 102 may disconnect from the communication session when the computing device 102 is moved outside the particular area of the area computing device 108. In some examples, the area computing device 108 can utilize an ultrasonic wireless transceiver to establish a communication session with computing devices within the particular area. The ultrasonic wireless transceiver can utilize a wireless signal that does not easily pass through physical barriers. In this way, the area computing device 108 may not be able to communicate with computing devices beyond the physical barriers of the particular area.

As described herein, the computing device 102 may want to pair with or establish a communication session with the area computing device 108 when entering the particular area of the area computing device 108. However, the computing device 102 may have limited electrical resources and utilizing an ultrasonic receiver or transceiver to search for the area computing device 108 may utilize a relatively large quantity of the limited electrical resources. In these examples, the computing device 102 can utilize a motion sensor device 110 to determine when the computing device 102 has moved from a first location to a second location. In this way, the computing device 102 can determine a likelihood of the computing device 102 being within the particular area of the area computing device 108. For example, the computing device 102 can be moved from an office to the conference room that includes the area computing device 108.

The computing device 102 can activate a receiver device 112 in response to the motion sensor device 110 indicating the computing device 102 has moved from the first location to the second location. In these examples, the receiver device 112 can be a low power receiver device or transceiver device. That is, the receiver device 112 can be separate from the communication device 114, which can be a high power communication device. The receiver device 112 can be a Bluetooth Low Energy (BLE) device or other type of receiver that is able to operate at relatively low power levels or utilize relatively lower electrical resources of the computing device 102.

The receiver device 112 can be activated to listen for a beacon or signal provided by the area computing device 108. For example, the area computing device 108 can send out a beacon or broadcast signal through a first communication path 116-1 that can be received at the receiver device 112. That is, the area computing device 108 can include a low power transmitter or transceiver, such as a BLE device, to transmit the beacon to devices that are within a communication range of the area computing device 108. In this way, the computing device 102 can identify that the area computing device 108 is within communication range without having to utilize the relatively greater quantity of electrical resources of the communication device 114 (e.g., ultrasonic wireless device, etc.).

The computing device 102 can activate the communication device 114 in response to receiving the beacon or signal from the area computing device 108. In this way, the computing device 102 can establish a communication session with the area computing device 108 utilizing the communication device 114. As described herein, the communication device 114 can be a high power transceiver or transmitter device to transmit and/or receive data with the area computing device 108. For example, the communication device 114 can provide image data and/or audio data to the area computing device through the communication path 116-2.

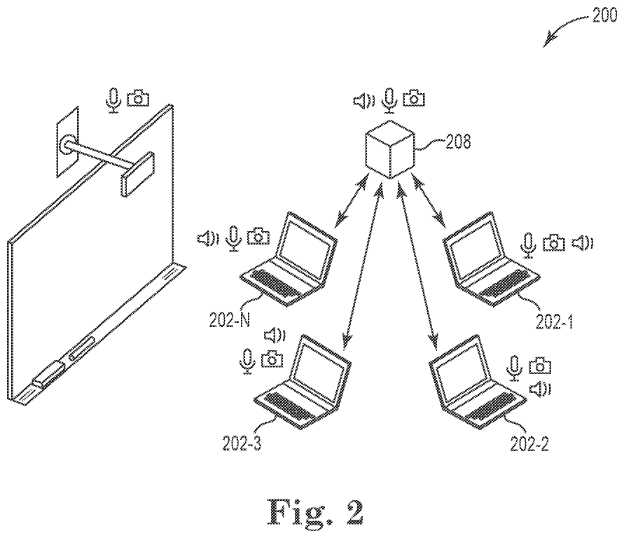

FIG. 2 illustrates an example of a system 200 for communication device activations. In some examples, the system 200 includes the same or similar elements as system 100 as referenced in FIG. 1. For example, the system 200 is positioned within a designated area (e.g., particular area, conference room, area that includes an area computing device, etc.). In some examples, the system 200 includes an area computing device 208. In some examples, the area computing device 208 includes a computing device designated for the designated area. For example, the area computing device 208 can include a server, cloud resource, or other computing resource that includes resources associated with the designated area.

In some examples, the area computing device 208 includes communication hardware to be utilized for the designated area. In some examples, the communication hardware includes microphones, cameras, speakers, communication drivers, virtual communication drivers, network connections, wireless transmitters, and/or other devices that are utilized to communicate with remote devices. In some examples, the area computing device 208 can utilize the communication hardware to generate an area profile for the designated area during a communication session with a communication application. As described herein, the area profile includes data collected from the area including from the communication hardware associated with the area computing device 208 and communication hardware from computing devices 202-1, 202-2, 202-3, 202-N (collectively referred to as computing devices 202) positioned within the designated area.

In some examples, the designated area includes a plurality of computing devices 202 that are mobile computing devices that can be easily moved into the designated area and outside the designated area by corresponding users. In this way, the area computing device 208 can monitor computing devices 202 entering and exiting the designated area. In some examples, the area computing device 208 sends a broadcast message or beacon utilizing a low power transmitter device (e.g., BLE, etc.). As described herein, the computing devices 202 can include motion sensors that indicate when the computing devices 202 have moved from a first location to a second location. In this way, the computing devices 202 can be notified by a motion sensor when they enter the designated area of the system 200. The computing devices 202 can activate a corresponding low power receiver to receive the beacon from the area computing device 208. In addition, the computing devices 202 can activate an ultrasonic transmitter or ultrasonic transceiver to initiate a communication session with the area computing device 208 in response to receiving the beacon from the area computing device 208. The computing devices 202 can then provide audio data and/or video data from corresponding communication hardware to the area computing device 208 during the communication session.

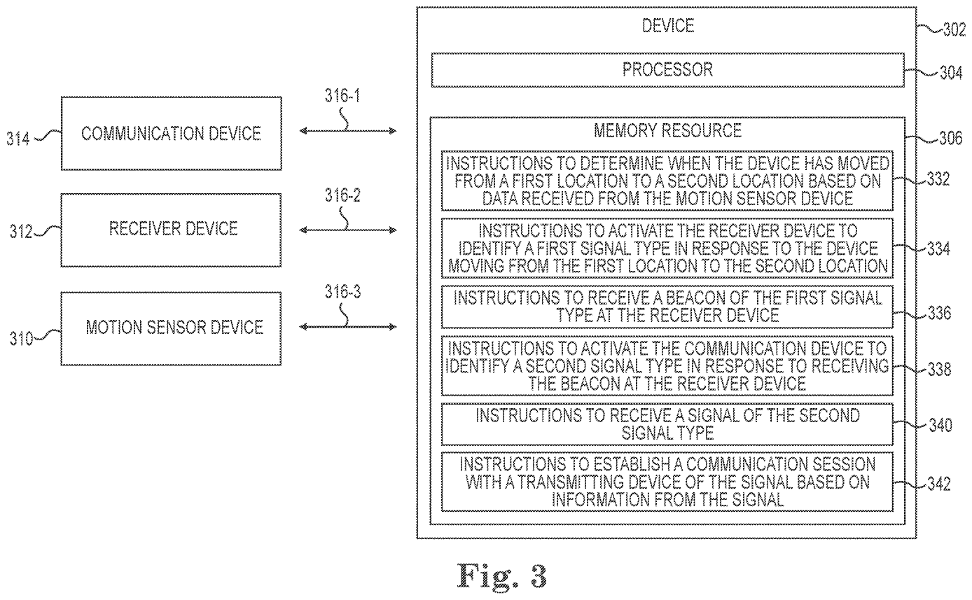

FIG. 3 illustrates an example of a device 302 for communication device activations. In some examples, the device 302 is a computing device that includes a processor 304 and a memory resource 306 to store instructions 332, 334, 336, 338, 340, 342 that are executed by the processor 304 to perform particular functions. In some examples, the device 302 is communicatively coupled to a communication device 314 through a first communication path 316-1, a receiver device 312 through a second communication path 316-2, and/or a motion sensor device 310 through a third communication path 316-3. In some examples, the communication paths 316-1, 316-2, 316-3 allows the device 302 to send and receive signals (e.g., communication signals, electrical signals, etc.) with other devices and/or internal devices. In some examples, the device 302 is able to execute the methods described herein.

The device 302 includes instructions 332 stored by the memory resource 306 that is executed by the processor 304 to determine when the device 302 has moved from a first location to a second location based on data received from the motion sensor device 310. The motion sensor device 310 can be a device that detects when the device 302 has been moved from the first location to the second location. In some examples, the motion sensor device 310 can be an accelerometer or gyroscope type device that can determine when the device 302 has been moved relative to gravity and/or has accelerated in a particular direction.

In some examples, the device 302 can utilize threshold values to determine when the device 302 has moved locations compared to being repositioned at a single location. For example, the device 302 can utilize a threshold quantity of movement such that a measured quantity of movement from the motion sensor device 310 can be compared to the threshold quantity of movement. In this example, a measured quantity of movement that is greater than the threshold quantity of movement can indicate that the device 302 has changed locations while a measured quantity of movement that is less than the threshold quantity of movement can indicate that the device 302 is in the same location. In this way, the measured quantity of distance can be utilized to determine if the device 302 has moved a particular distance from a previous location. In some examples, the particular distance can indicate whether the device 302 may have been moved from a location that is outside a communication range of a remote device to a location that is within the communication range of the remote device.

In some examples, the device 302 can be positioned at a first location where the device 302 is unable to wirelessly connect with a remote device utilizing the communication device 314. In these examples, the device 302 may have deactivated the communication device 314 and/or the receiver device 312 to conserve electrical energy. In this way, the device 302 can conserve electrical energy by keeping the communication device 314 and/or the receiver device 312 disabled until it is determined that the device 302 has moved a particular distance, which could result in the device 302 being within a communication distance of a remote device. In addition, the device 302 can increase security by deactivating the communication device 314 and/or receiver device 312. For example, the device 302 may be less susceptible to unauthorized remote devices connecting to the device 302 through the communication device 314 and/or receiver device 312.

The device 302 includes instructions 334 stored by the memory resource 306 that is executed by the processor 304 to activate the receiver device 312 to identify a first signal type in response to the device 302 moving from the first location to the second location. The device 302 can activate the receiver device 312 in response to the device 302 moving from the first location to the second location by providing electrical power to the receiver device 312 to allow the receiver device 312 to receive a particular type of signal associated with the receiver device 312. For example, the receiver device 312 can be a BLE receiver or BLE transceiver that can receive a BLE beacon from the remote computing device when the device 302 is within communication range of the remote computing device.

In some examples, the device 302 can include instructions to activate a first timer in response to the device 302 moving from the first location to the second location. In these examples, the first timer limits a quantity of time for receiving the beacon. In some examples, the receiver device 312 can be activated for a particular quantity of time. In this way, the first timer can be activated to control a quantity of time the receiver device 312 is activated without receiving the beacon. For example, the receiver device 312 can be activated at the same or similar time as the first timer and deactivated if the receiver device 312 does not receive the beacon from the remote computing device. In this way, the device 302 can conserve electrical energy by deactivating the receiver device 312 when the beacon is not received after a particular quantity of time.

The device 302 includes instructions 336 stored by the memory resource 306 that is executed by the processor 304 to receive a beacon of the first signal type at the receiver device 312. As described herein, the receiver device 312 can receive the beacon that is a first type of signal (e.g., BLE signal type, wireless signal with a first wavelength range, etc.). As described herein, the receiver device 312 can be a relatively lower power receiver device such that a relatively low quantity of electrical energy is utilized to power the receiver device 312. In some examples, the receiver device 312 can receive wireless signals and/or beacons within a first wavelength range that is different than a second wavelength range associated with the communication device 314.

In these examples, the device 302 can include instructions to activate a second timer in response to receiving the beacon. In these examples, the second timer limits a quantity of time for receiving the signal. When the beacon is received, the second timer can be activated to limit a quantity of time the communication device 314 listens for the signal from the remote computing device. For example, the second timer can be activated at the same or similar time as the communication device 314 is activated in response to receiving the beacon at the receiver device 312. In some examples, the receiver device 312 can be deactivated in response to receiving the beacon and/or in response to activating the communication device 314.

The device 302 includes instructions 338 stored by the memory resource 306 that is executed by the processor 304 to activate the communication device 314 to identify a second signal type in response to receiving the beacon at the receiver device. As described herein, the beacon can indicate that a particular remote device is within a communication range of the device 302. In this way, the beacon can be an indication that a particular remote device is within communication range that can be utilized with the communication device 314. When the beacon is received by the receiver device that utilizes a first type of wireless communication, the communication device 314 that utilizes a second type of wireless communication can be activated. As described herein, the receiver device 312 can be a BLE device and the communication device 314 can be an ultrasonic wireless device.

As described herein, the communication device 314 can be an ultrasonic communication device that utilizes a wireless signal limited by physical barriers. The communication device can transmit and receive signals that utilize a wireless signal at a wavelength that may not be transmitted through physical boundaries. This can limit the communication range of the remote computing device to a particular designated area that is enclosed by physical barriers (e.g., walls, etc.). In this way, the device 302 may not be able to utilize the communication device 314 outside of the designated area that includes the remote computing device.

In some examples, the device 302 can deactivate the communication device 314 when the device 302 is moved from within the designated area to a location outside the designated area. For example, the device 302 can determine when the signal is lost between the communication device 314 and the area computing device within the designated area. In this example, the device 302 can deactivate the communication device 314 in response to determining the signal is lost and/or determining that the device 302 is no longer within the designated area.

Deactivating the communication device 314 when the device 302 is not within the designated area or in communication with an area computing device can increase security of information being transferred by the communication device 314. For example, the communication device 314 can be utilized to transmit video and audio data to the area computing device. Deactivating the communication device 314 when the device 302 is outside the designated area can increase privacy of a user of the device 302 since the data transmitted by the communication device 314 can be sensitive audio and/or video data associated with the user.

The device 302 includes instructions 340 stored by the memory resource 306 that is executed by the processor 304 to receive a signal of the second signal type. In some examples, the signal of the second type can be a signal that is transmitted utilizing a second type of device. As described herein, the second signal can be an ultrasonic signal that is received by the communication device 314 when the communication device 314 is an ultrasonic transceiver. In this way, the signal of the second signal type can be different than the beacon. In these examples, the beacon and the signal of the second signal type can be received by the same computing device. For example, an area computing device can transmit the beacon to the receiver device 312 and transmit the signal to the communication device 314.

The device 302 can include instructions to decode the signal of the second signal type to extract the information from the signal. In some examples, the signal received by the communication device 314 can include information that can be decoded by the device 302. For example, the signal received from the area computing device or remote computing device can include information for pairing with the area computing device or remote computing device. In this way, the device 302 can utilize the information received from the signal of the second signal type can be utilized to establish a communication session with an area computing device.

The device 302 includes instructions 342 stored by the memory resource 306 that is executed by the processor 304 to establish a communication session with a transmitting device of the signal based on information from the signal. As described herein, the communication session can be a pairing between the device 302 and the transmitting device such that information from the device 302 can be transmitted to the transmitting device. As described herein, the transmitting device can be a remote computing device and/or area computing device. In this way, the information from the signal can be instructions for a handshake or other type of protocol for establishing the communication session.

As described herein, the device 302 includes a processor 304 communicatively coupled to a memory resource 306 through a communication path. As used herein, the processor 304 can include, but is not limited to: a central processing unit (CPU), an application specific integrated circuit (ASIC), a field programmable gate array (FPGA), a metal-programmable cell array (MPCA), a semiconductor-based microprocessor, or other combination of circuitry and/or logic to orchestrate execution of instructions 332, 334, 336, 338, 340, 342. In other examples, the device 302 includes instructions 332, 334, 336, 338, 340, 342, stored on a machine-readable medium (e.g., memory resource 306, non-transitory computer-readable medium, etc.) and executable by a processor 304. In a specific example, the processor 304 utilizes a non-transitory computer-readable medium storing instructions 332, 334, 336, 338, 340, 342, that, when executed, cause the processor 304 to perform corresponding functions.

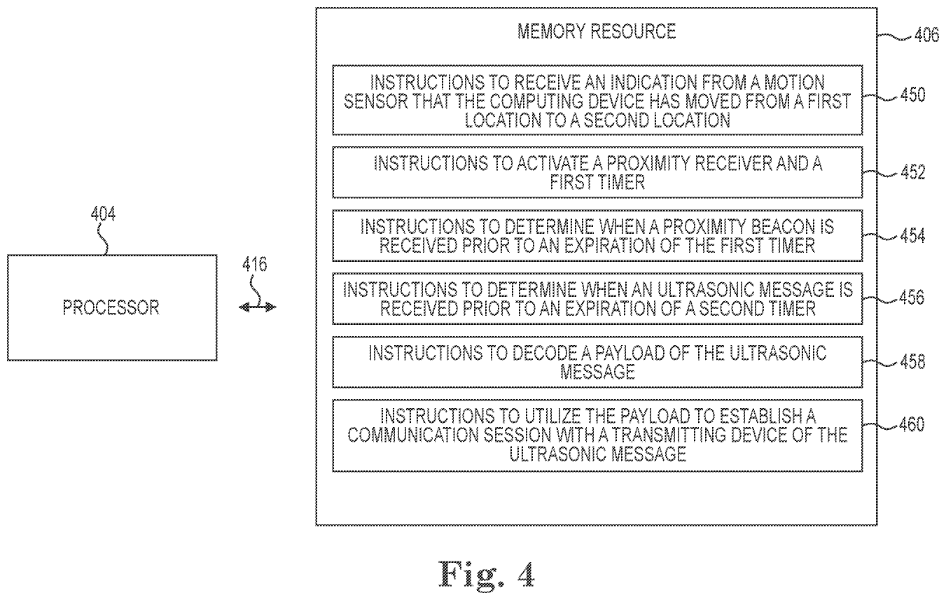

FIG. 4 illustrates an example of a memory resource 406 for communication device activations. In some examples, the memory resource 406 can be a part of a computing device or controller that can be communicatively coupled to a computing system. For example, the memory resource 406 can be part of a device 302 as referenced in FIG. 3. In some examples, the memory resource 406 can be communicatively coupled to a processor 404 that can execute instructions 450, 452, 454, 456, 458, 460, stored on the memory resource 406. For example, the memory resource 406 can be communicatively coupled to the processor 404 through a communication path 416. In some examples, a communication path 416 can include a wired or wireless connection that can allow communication between devices and/or components within a single device.

The memory resource 406 may be electronic, magnetic, optical, or other physical storage device that stores executable instructions. Thus, a non-transitory machine-readable medium (MRM) (e.g., a memory resource 406) may be, for example, a non-transitory MRM comprising Random-Access Memory (RAM), read-only memory (ROM), an Electrically Erasable Programmable ROM (EEPROM), a storage drive, an optical disc, and the like. The non-transitory machine-readable medium (e.g., a memory resource 406) may be disposed within a controller and/or computing device. In this example, the executable instructions 450, 452, 454, 456, 458, 460, can be “installed” on the device. Additionally, and/or alternatively, the non-transitory machine-readable medium (e.g., a memory resource 406) can be a portable, external, or remote storage medium, for example, which allows a computing system to download the instructions 450, 452, 454, 456, 458, 460 from the portable/external/remote storage medium. In this situation, the executable instructions may be part of an “installation package”.

In some examples, the memory resource 406 includes instructions 450 to receive an indication from a motion sensor that the computing device has moved from a first location to a second location. As described herein, the motion sensor can be a device that detects movement of a particular device. The motion sensor can detect movement of the computing device or device that encloses the memory resource 406. In these examples, the motion sensor can send a signal to the processor 304. In these examples, the signal can be a notification that the computing device has moved from a first location to a second location.

In these examples, the memory resource 406 can include instructions to activate an operating system of the computing device in the indication that the computing device has moved from a first location to a second location. In some examples, the notification or signal received from the motion sensor can be utilized to initiate the processor 304 to activate the operating system of a computing device. In some examples, the operating system of the computing device can include instructions that supports the basic functions of a computing device, such as, but not limited to: scheduling tasks, executing applications, controlling peripheral devices, activating communication devices, deactivating communication devices, and/or perform other functions associated with computing devices. The operating system can be utilized to activate a proximity receiver or transceiver as described further herein.

In some examples, the memory resource 406 includes instructions 452 to activate a proximity receiver and a first timer. The proximity receiver can be a receiver or transceiver device that can be utilized to receive or send wireless communication. The proximity receiver can receive signals from remote computing devices within a particular wavelength range and/or utilizing a particular communication protocol. In some examples, the proximity receiver can be a relatively low power receiver that can utilize less electrical energy compared to other types of wireless receivers and wireless transceivers. In some examples, the proximity sensor is a Bluetooth Low Energy (BLE) receiver. In this way, the electrical power to activate the proximity receiver can be relatively less than the electrical power to activate an ultrasonic receiver and/or ultrasonic transceiver.

In some examples, the memory resource 406 can include instructions to deactivate the proximity sensor upon expiration of the first timer. In some examples, the proximity sensor is deactivated when a signal is not received prior to the expiration of the first timer. In this way, the proximity sensor can be deactivated when a particular remote computing device is not within communication range. Thus, the quantity of electrical power utilized by the computing device can be lowered when the remote computing device is not within the communication range. Furthermore, the proximity sensor can be deactivated to prevent the computing device from pairing with unauthorized devices when the particular remote computing device is not within the communication range.

In some examples, the memory resource 406 includes instructions 454 to determine when a proximity beacon is received prior to an expiration of the first timer. As described herein, proximity beacon can be received from the transmitting device (e.g., remote computing device, area computing device, etc.). The proximity beacon can be transmitted by a remote computing device such as an area computing device that is designated to a particular area. The proximity beacon can indicate that the remote computing device is within communication range utilizing a different communication device. For example, the beacon can be received utilizing a BLE receiver to indicate that the computing device is within communication range utilizing an ultrasonic transmitter and/or ultrasonic transceiver. In this way, the relatively low energy communication device can be utilized to determine when a high energy communication device can be utilized to communicate with a remote computing device.

In some examples, the memory resource 406 includes instructions 456 to determine when an ultrasonic message is received prior to an expiration of the second timer. In some examples, an ultrasonic communication device (e.g., ultrasonic receiver, ultrasonic transmitter, ultrasonic transceiver, etc.) can be activated in response to the proximity beacon being received and a second timer can be activated. In this way, the ultrasonic transceiver can listen for the ultrasonic message for a particular quantity of time that corresponds to the second timer. That is, the ultrasonic communication device can be activated for a period of time that corresponds to the second timer. When an ultrasonic message is received at the ultrasonic communication device prior to the expiration of the second timer, the computing device can establish a communication session with the transmitting device. However, the ultrasonic communication device can be deactivated when the ultrasonic message is not received prior to the expiration of the second timer.

In some examples, the memory resource 406 includes instructions 458 to decode a payload of the ultrasonic message. In some examples, the ultrasonic message can be an encrypted message or message that includes a payload that can be decoded. In these examples, the received ultrasonic message can be decoded such that the instructions associated with the ultrasonic message can be executed. In some examples, the ultrasonic message can include information associated with the remote computing device (e.g., device transmitting the beacon and/or ultrasonic message, etc.). As used herein, the payload refers to an intended message of the ultrasonic message. For example, a header and metadata of the ultrasonic message can be utilized to enable the payload delivery to the computing device.

In some examples, the memory resource 406 includes instructions 460 to utilize the payload to establish a communication session with a transmitting device of the ultrasonic message. In this way, the payload can indicate a handshake to initiate the communication session with the transmitting device. As described herein, the payload can include information and/or instructions for establishing a communication session with the remote computing device. Thus, the payload of the ultrasonic message can be utilized to establish a communication session with the remote computing device utilizing the ultrasonic communication device.

The instructions 450, 452, 454, 456, 458, 460 can be executed to conserve electrical energy utilized by a computing device and/or provide additional privacy protection of users of the computing device. By activating and deactivating the high power communication devices in response to movement and receiving a beacon utilizing a low power communication device can lower power usage. In addition, ensuring that a communication session is established in response to movement and receiving the beacon can lower the chance of establishing a communication session with an unauthorized remote computing device.

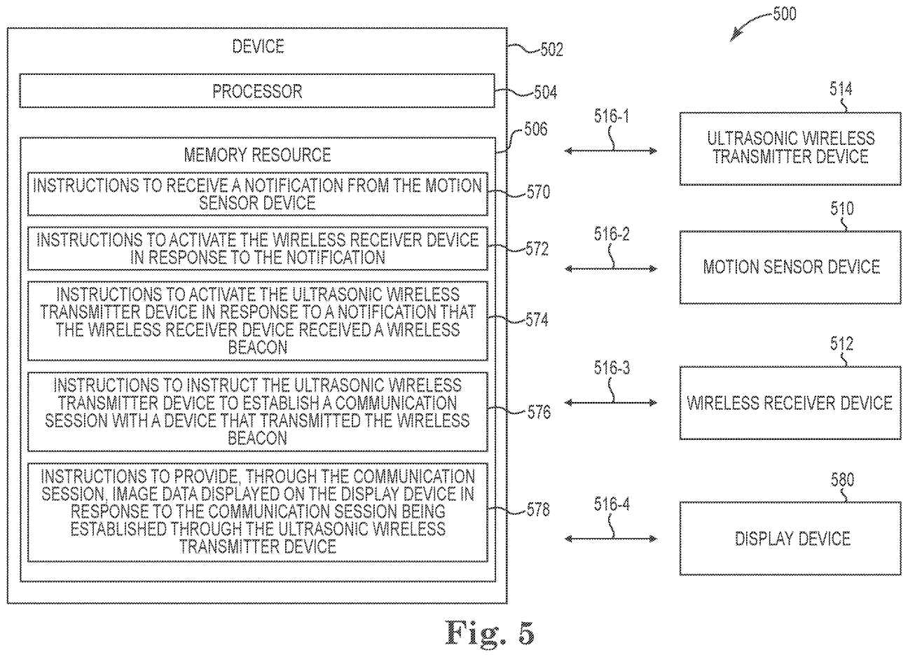

FIG. 5 illustrates an example of a system 500 for communication device activations. In some examples, the system 500 includes a device 502 that includes a processor 504 communicatively coupled to a memory resource 506. In some examples, the device 502 can include a computing device that includes a processor 504 and a memory resource 506 storing instructions 570, 572, 574, 576, 578, that are executed by the processor 504 to perform particular functions.

In some examples, the system 500 includes an ultrasonic wireless transmitter device 514 communicatively coupled to the device 502 through a first communication path 516-1. In some examples, the ultrasonic wireless transmitter device 514 sends and receives audio data and/or video data to the device 502. In some examples, the system 500 includes a motion sensor device 510 communicatively coupled to the device 502 through a second communication path 516-2.

The system 500 can include a wireless receiver device 512 that is communicatively coupled to the device 502 through a third communication path 516-3. In some examples, the system 500 includes a display device 580 communicatively coupled to the device 502 through a fourth communication path 654-4.

The device 502 includes instructions 570 stored by the memory resource 506 that can be executed by the processor 504 to receive a notification from the motion sensor device 510. In these examples, the notification can indicate that the device 502 has moved from a first location to a second location. That is, the processor 504 can determine when the notification indicates that the device 502 has moved from a first location to a second location. In a specific example, the processor 504 can determine when the notification indicates that the device 502 has moved within an area that includes an area computing device. In these examples, the communication session is established with the area computing device.

The device 502 includes instructions 572 stored by the memory resource 506 that can be executed by the processor 504 to activate the wireless receiver device 512 in response to the notification. The wireless receiver device 512 can be a low energy receiver device (e.g., BLE receiver, etc.). As described herein, the wireless receiver device 512 can be activated in response to movement of the device 502 for a particular period of time to determine if a beacon is received from a remote computing device. In some examples, the wireless beacon can be a message or notification that the device 502 is within a communication range of the area computing device.

The device 502 includes instructions 574 stored by the memory resource 506 that can be executed by the processor 504 to activate the ultrasonic wireless transmitter device 514 in response to a notification that the wireless receiver device 512 received a wireless beacon. As described herein, the ultrasonic wireless transmitter device 514 can be a high power transmitter device that utilizes a greater quantity of electrical energy during operation compared to the wireless receiver device 512. In this way, the ultrasonic wireless transmitter device 514 can be activated when there is motion identified by the motion sensor device 510 and when a wireless beacon is received at the wireless receiver device 512.

The device 502 includes instructions 576 stored by the memory resource 506 that can be executed by the processor 504 to instruct the ultrasonic wireless transmitter device 514 to establish a communication session with a device that transmitted the wireless beacon. As described herein, the device that transmitted the wireless beacon can be an area computing device or remote computing device. Establishing the communication session can include pairing with the remote computing device such that data can be transmitted and/or received utilizing the ultrasonic wireless transmitter device 514.

The device 502 includes instructions 578 stored by the memory resource 506 that can be executed by the processor 504 to provide, through the communication session, metadata, audio data, and image data displayed on the display device 580 in response to the communication session being established through the ultrasonic wireless transmitter device 514. As used herein, the metadata can describe the type of data being transmitted through the communication session to a remote computing device. In this way, the remote computing device can identify the type of data being received by the device 502. As described herein, image data (e.g., still images, video, etc.) can be provided to the remote computing device utilizing the ultrasonic wireless transmitter device 514 utilizing the established communication session. In some examples, the image data displayed on the display device 580 can be relatively sensitive data for a user of the device 502. In these examples, the instructions 570, 572, 574, 576, 578 can be utilized to increase privacy and/or security of the image data being displayed on the display device 580.

In some examples, the system 500 includes a microphone device. In these examples, the processor 504 is to provide, through the communication session, audio data received by the microphone device in response to the communication session being established through the ultrasonic wireless transmitter device 514. In a similar way to the image data displayed on the display device 580, the audio data collected by an embedded microphone of the device 502 or peripheral microphone of the device 502 can collect audio data and the audio data can be provided to the remote computing device through the communication session utilizing the ultrasonic wireless transmitter device 514. The instructions 570, 572, 574, 576, 578 can be utilized to increase privacy and/or security of the audio data being collected by the microphone device.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples, and data provide a description of the system and methods of the disclosure. Since many examples can be made without departing from the spirit and scope of the system and method of the disclosure, this specification merely sets forth some of the many possible example configurations and implementations.

What is claimed is:

1. A device, comprising:
a motion sensor device;
a receiver device;
a communication device; and
a processor to:
determine when the device has moved from a first location to a second location based on data received from the motion sensor device;
activate the receiver device to identify a first signal type in response to the device moving from the first location to the second location;
receive a beacon of the first signal type at the receiver device;
activate the communication device to identify a second signal type in response to receiving the beacon at the receiver device;
receive a signal of the second signal type; and
establish a communication session with a transmitting device of the signal based on information from the signal.

2. The device of claim 1, wherein the processor is to decode the signal of the second signal type to extract the information from the signal.

3. The device of claim 1, wherein the communication device is an ultrasonic communication device that utilizes a wireless signal limited by physical barriers.

4. The device of claim 1, wherein the processor is to activate a first timer in response to the device moving from the first location to the second location, wherein the first timer limits a quantity of time for receiving the beacon.

5. The device of claim 1, wherein the processor is to activate a second timer in response to receiving the beacon, wherein the second timer limits a quantity of time for receiving the signal.

6. A non-transitory memory resource storing machine-readable instructions stored thereon that, when executed, cause a processor of a computing device to:
receive an indication from a motion sensor that the computing device has moved from a first location to a second location;
activate a proximity receiver and a first timer;
determine when a proximity beacon is received prior to an expiration of the first timer;
activate an ultrasonic communication device and a second timer;
determine when an ultrasonic message is received prior to an expiration of the second timer;
decode a payload of the ultrasonic message; and
utilize the payload to establish a communication session with a transmitting device of the ultrasonic message.

7. The memory resource of claim 6, wherein the processor is to activate an operating system of the computing device in the indication that the computing device has moved from a first location to a second location.

8. The memory resource of claim 6, wherein the proximity sensor is a Bluetooth Low Energy (BLE) receiver.

9. The memory resource of claim 6, wherein the proximity beacon is received from the transmitting device,

10. The memory resource of claim 6, wherein the processor is to deactivate the proximity sensor upon expiration of the first timer.

11. The memory resource of claim 6, wherein the payload indicates a handshake to initiate the communication session with the transmitting device.

12. A system, comprising:
a motion sensor device;
a wireless receiver device;
an ultrasonic wireless transmitter device;
a display device; and
a processor to:
receive a notification from the motion sensor device;
activate the wireless receiver device in response to the notification;
activate the ultrasonic wireless transmitter device in response to a notification that the wireless receiver device received a wireless beacon;
instruct the ultrasonic wireless transmitter device to establish a communication session with a device that transmitted the wireless beacon; and
provide, through the communication session, metadata, audio data, and image data displayed on the display device in response to the communication session being established through the ultrasonic wireless transmitter device.

13. The system of claim 12, comprising a microphone device, wherein the processor is to provide, through the communication session, the audio data received by the microphone device in response to the communication session being established through the ultrasonic wireless transmitter device.

14. The system of claim 13, wherein the processor is to determine when the notification indicates that a device has moved from a first location to a second location.

15. The system of claim 12, wherein the processor is to determine when the notification indicates that a device has moved within an area that includes an area computing device, wherein the communication session is established with the area computing device.
